(19) United States
(12) Patent Application Publication
(10) Pub. No.: US 2012/0055279 A1
(43) Pub. Date: Mar. 8, 2012

(54) Vehicle Throttle and Brake Control System Employing Instinctive Driver Response for Enhanced Vehicle Control

(76) Inventor: Victor Van Saanen, Spring Valley, CA (US)

(21) Appl. No.: 13/226,430

(22) Filed: Sep. 6, 2011

Related U.S. Application Data
(60) Provisional application No. 61/402,857, filed on Sep. 7, 2010.

(51) Int. Cl. G05G 1/44

(52) U.S. Cl. 74/513

(57) ABSTRACT

An improved motor vehicle speed and braking control system configured to maximize performance and response times for braking to a driver's instinctual physiological and psychological response to a perceived need to decelerate. The system provides a throttle pedal and brake pedal system optimally positioned and configured to allow for braking and an immediate change of engine power to idle once a user touches or activates safety switches by contact with them directly or with the brake pedal or a sliding of the throttle pedal depending on the configuration. Accidental acceleration during an attempt to brake is eliminated by the system.

### BACKGROUND OF THE INVENTION

1. Field of the Invention

This application claims priority to U.S. Provisional Application Ser. No. 61/402,857 filed on Sep. 7, 2010 and incorporated in its entirety herein by reference.

The present invention relates generally to systems and methods designed to reduce the dangers presented by intentional and unintentional actions by drivers employing pedals for vehicle acceleration and braking. More particularly, it relates to an improved design and configuration of foot control areas of present motor vehicles, such that it takes advantage of a driver's natural and instinctual physiological and psychological response in rapidly changing traffic conditions, to achieve quicker and more accurate pedal control and employment.

2. Prior Art

Motor vehicle crashes are the leading cause of injury and death in America. The national safety council (NSC) estimates that several specific driver behaviors and errors contribute to ninety percent (90%) of all motor vehicle crashes. Crashes caused solely by vehicle or external factors (e.g., the failure of one or more vehicle components or road or weather conditions) account for the other ten percent (10%) of vehicle crashes.

At its most basic level, driving requires that a driver have the adequate mental and physical abilities of sight, hearing and feeling, the mental and physical ability to correctly interpret the proper reaction to what is being seen, heard and felt, and the necessary mental and physical condition to carry out the correct reaction. These abilities will of course change at different rates for different people as they get older. Not surprisingly, teenage drivers, who must learn new skills needed for driving and who frequently engage in high-risk behaviors, such as speeding and/or driving after using alcohol or drugs, have the highest fatality rate from motor vehicle crashes of all age groups, followed closely, based on miles driven, by drivers 65 years old and older. People 65 and older are the fastest growing demographic in the U.S., and by 2030, a quarter of all licensed drivers in the United States will be in that age group.

Age alone, however, is not a reliable indicator of driving ability. Some people in their 90 s and beyond are more healthy and fit for driving than many people half their age. Still, as a general rule, it can be said that the older a person gets, the bigger the risk he or she tends to pose as a safe driver. As the over-65 population grows, more elderly people will be driving more miles and more frequently. A fact which has led the National Highway Traffic Safety Administration (NHTSA) to predict that the number of elderly driver traffic fatalities in the U.S. could triple by 2030.

One phenomena that afflicts young and old drivers alike is a driver response known as “pedal error” or as an unintentional acceleration while attempting to brake the vehicle. A third type of driver could be added to the list of those afflicted if one were to consider an experienced driver, who for the first time, is starting a different and unfamiliar car in which he or she has had absolutely no experience.

It must be noted that in this present application the term ‘pedal error’ is to be defined to include any misuse of a motor vehicle's foot controls, such as hitting the accelerator when intending to hit the brake, slipping from the brake to the accelerator, or similar occurrences where the driver is not intending to press the accelerator but does so. In addition, the term further is employed with persons prone to pedal error type conditions, for instance drivers operating under especially stressful conditions, such as any driver with very little affinity for, or understanding of, mechanical systems, and their often complex procedures.

There has been little public notice of pedal error until two horrendous accidents. Once such occurrence was in Santa Monica, Calif. in 2003. A second occurrence was in San Diego County, Calif. in 2009. Both incidents made headlines nationally and even world wide.

In the Santa Monica incident, during an open-field farmer's market in Santa Monica attended by hundreds of patrons, an 86 year old man, while looking for a parking spot, attempted to stop for a pedestrian. However, when he stepped on the throttle instead of the brake, and the car wouldn't stop, he continued his mistake by continously pumping the gas pedal which he thought was his brake. During the Santa Monica incident, the car proceeded through the market for approximately 2 blocks (750 feet), traveling as fast as 70 mph before coming to a stop when the vehicle finally landed in a ditch. As a result, 11 people were killed and 63 were injured, many critically so.

In the San Diego County incident, a highly experienced California Highway Patrolman, was off duty and traveling with members of his family. This driver was driving a newer Lexus vehicle which had been loaned to him from a dealer and he was as such unfamiliar with the vehicle. While the vehicle was being driven on the highway, an emergency telephone call was placed from a passenger sitting in the rear of the vehicle. The passenger was screaming repeatedly that the throttle was jammed on the vehicle and the car had accelerated to 100 miles per hour when suddenly the telephone call ceased.

Later it was found that the car had approached an intersection at a high rate of speed and missed the turn and gone air born for at least 150 feet before landing and bursting into flames. The driver and his family were all killed in the crash.

The San Diego incident shows that even a highly experienced police officer, who would normally drive safely with his family in the car, can be so unfamiliar with a vehicle as to lose control.

In both the Santa Monica and San Diego crashes, if the present invention had been installed in the vehicles, the accidents would have been prevented. While one accident was a mistake by an elderly driver and the other a mistake of a highly trained driver, the common problem was faulty pedal designs of conventional vehicles. Such faulty designs continue to cause accidents.

Both the Santa Monica and San Diego accidents are examples of conventional “pedal error”. Because of the national and even world wide attention these two events gained, they received intensive review by the NTSB, (National Transportation Safety Board) in the United States which discerned that pedal error was the root cause.

Thousands of pedal errors are made all over the U.S. every year and little publicity was given them if only one or two fatalities occurred. Further, without living and reliable witnesses to recount the event, there is little possibility the actual cause of such crashes are properly identified as pedal error. The number of pedal error type fatalities which are misidentified every year is estimated in the hundreds of thousands worldwide.

There has been identified what is believed as four types of drivers that are associated with an increased probability of improper foot control usage, including the unintentional and mistaken use of throttle instead of brake referred to as “pedal error”. It happens more frequently to senior citizens, to young drivers just learning to drive, to people who are driving an unfamiliar car, and to those drivers who have little affinity for, or understanding of, mechanical systems and procedures.

The problems experienced with senior drivers, new drivers, and driving an unfamiliar car are almost self-explanatory. Drivers with little affinity or understanding of mechanical systems and procedures are another matter entirely and may require considerable sensitive thought to understand. Experience has shown that those who are very mechanically inclined are able to easily overcome any system or procedure that is not exactly logical and correct, or which may be unnecessarily difficult to understand and operate. Such persons are naturally oriented to details and particulars. If there is something wrong in the process, they will simply overcome the difficulty and accomplish control.

However, those who are not at all mechanically inclined, tend to consider such detailed systems and procedures from a very universal and overall point of view. They don't understand the detailed process as much as the overall result. The question their mind will posse is, “what is the total human value of the process; is the overall process easy, simple and correct”. If it is not, they usually don't understand why; they just have a strong intuitive perception that something is not right.

Such perception often leads to confusion and a hesitation to act correctly during emergency type situations. It will usually also be noticed that this type of person will never seem completely relaxed behind the wheel, sitting at attention with both hands on the wheel and staring straight ahead at traffic. It is this type of driver that has lead the inventor to discover a very serious, long standing flaw in the design of the foot control system of motor vehicles and has invented a correction to such flaw.

This most serious flaw in the design of motor vehicle foot controls that has existed since the very beginning of automotive construction, forces a driver during emergency type situations, to perform a maneuver which is inherently awkward. Further, it is time consuming and the exact opposite of the normal and instinctual human response in such situations.

The two most important functions in the safe control of an automobile are both directional control and speed control. Any misuse of directional control (steerage) will obviously have a negative effect on speed control. By the same token, any misuse of speed control by using throttle or the brake can result in a negative effect on steering, as well as a resulting accident from acceleration.

With regard to speed, the brake is of greatest importance. It is absolutely imperative that immediate braking be applied to slow the vehicle any time when necessary. There is seldom however, any need for immediate emergency acceleration.

However, immediate or instantaneous braking using conventional controls is impossible. This is because conventionally in cars and trucks, the right foot of the driver is employed to control both the brake and throttle. From a time standpoint, the driver's right foot is most often riding the throttle pedal. Because study has shown that it takes at least one and one-half to two seconds for the driver to move their foot from throttle to brake, instantaneous braking while the vehicle is moving during emergency situations happens far too late. During the lag caused by foot-transfer from throttle to brake, the vehicle can travel a large distance at high speeds. This is why many race car drivers employ one foot for the throttle and the other for braking. Since they do not have to transfer from one pedal to the other at high speeds, they have continuous control and instantaneous braking when needed.

As noted, the right pressing on the throttle pedal is incapable of applying instantaneous braking as it takes a minimum of one and one-half to two seconds for the right foot to go from throttle pedal to brake pedal in conventional vehicle designs. This is because it takes four steps for a driver to apply braking. First, they take pressure from their foot to reduce throttle to idle. Next they must raise the right foot above the throttle pedal. In a third action, the driver must move the raised foot, horizontally left, to a position hopefully centered over the brake pedal. Lastly, the driver must push their elevated foot forward to hopefully apply brakes in time to avoid whatever caused the braking reflex in the first place.

Such a time delay is most unacceptable in the rush of an emergency type situation and especially during high speed travel where the vehicle will travel many yards in each second. There are several situations that can often affect the ability to execute timely braking. First the driver's foot can move too far in the left direction to the left for the brake, or not far enough. This will cause the driver to miss the brake entirely by pushing down on the floor rather than the brake. Even if the driver realizes his mistake and correctly replaces his foot on the brake pedal, it is still usually too late to avoid an accident.

There are situations when the driver's foot or leg may be physically unable to move high enough and/or quick enough laterally, to be properly centered over the brake pedal. Thus, they will strike the brake shaft instead, and pressing on the floor to no avail.

There are also those circumstances that confuse certain drivers resulting in a late brake application or none at all. Further, there is always the worst scenario which occurs when the driver accidentally mistakes the throttle pedal for the brake which causes an accidental application of throttle instead of brake. Rather than slowing as intended, the vehicle will accelerate.

In any event, the ultimate result of any such occurrence can cause severe consequences. In emergency situations requiring instantaneous and effective braking, either there will be no braking, the actual braking will be too late, or worse, the driver will hit the wrong pedal causing accidental acceleration instead of the desired slowing of brakes.

As noted, it is often very difficult to determine the actual cause of an accident, especially if there are no surviving or reliable witnesses. Those accidents caused by improper speed control (no braking, late braking or accidental acceleration) may be referred to as “resultant causes” as there are usually several obscure “initial causes” that have brought about the final resultant act.

It is the object of the present invention to rectify the above noted problems with the disclosed foot control design of present utility and passenger motor vehicles with pedals configured to take advantage of natural human responses while driving.

It is a further object of this invention to employ the left foot as the primary braking foot and the right foot as an optional secondary braking foot to enhance driver control of vehicles.

It is another object of the invention herein to correct the very serious problems with conventional pedal designs in vehicles which are especially dangerous even near-emergency type situations.

It is an additional object of this invention, to provide a vehicle pedal control system that takes advantage of the positive instinctual physiological human response to approaching road conditions, to speed braking and a de-acceleration of vehicles.

Finally, it is an object of this invention, to rid vehicles of driver-caused delay from acceleration to braking, by removing the need to raise and laterally translate the driver's foot to brake the vehicle.

### SUMMARY OF THE INVENTION

The present invention provides systems and methods designed to prevent not only the unintentional misuse of vehicle foot controls, but the intentional abuse of controls as in unauthorized drag racing. Further, the device and method herein, takes advantage of the instinctive human response while driving to de-accelerate which is to move the control foot forward to both stop and brace the body of the driver, to achieve almost instantaneous braking of the vehicle.

A particularly preferred aspect of the preferred mode of the invention is the gradual conversion of pedal-type foot controls into panel-type foot controls, with the panel-type controls being substantially large planar members wherein the brake foot control panel covers a substantially wide portion of the driver's foot well.

Such design allows for the most direct and easiest access of either foot from any position to any desired control, especially the brake. Another preferred aspect of the present invention is the teaching wherein the shafts and linkages to foot control pedals and panels for all functions (e.g., throttle, brake, clutch, etc.) in each preferred mode described herein, are lengthened or shortened to achieve two substantially planar levels. That planar level highest from the floor would consist of the throttle and clutch control panels. The lower planar level would consist of all brake control panels and would be below the throttle and clutch control level and closer to the floor. Both planar control surfaces would lay in an approximate sixty-degree angle to the driver's level floor.

However, those skilled in the art will appreciate a plurality of alternative preferred angles and dimensions as to conform to ergonomic standards and the like, and which take advantage of normal human response to brake and brace, and are anticipated in this disclosure. As such, the preferred modes of the invention disclosed herein are noted to simply portray the overall intent and scope of the invention and should not be considered limiting, and any such design as would occur to those skilled in the art, which takes advantage of the human response to move the foot forward rather than sideways, is anticipated within the scope of this invention.

Such preferred designs as herein disclosed, significantly increase the ability of any driver's sliding foot to reach any desired control, and especially the brake, in the least distance and time and with the least physical and mental effort.

Additional preferred aspects to the present invention are as follows:

1) the use of forward and side control baffles to eliminate any possibility of unwanted obstacles interfering with control operation; and,
2) the generous use of side and forward foot stops to aid a driver's identification of a foot's correct position on proper controls by feel.

As will be clear in the description that follows, the objects of the invention provided by the various modes include, but are not limited to: the ability of either left or right foot to apply immediate braking pressure from any position; the minimization of either foot reaching the wrong control by mistake; minimization of obstructions accidentally interfering with control operations; minimization of the abuse of power, as in drag racing; minimization of the physical effort required to reach and operate a desired control; and, the maximization of a driver's subconscious feeling of competence as the system of control usage is logical, simple and easy to operate correctly.

A still further particularly preferred improvement is the fact that the present invention eliminates the unnatural, awkward and time consuming necessity of the conventional designs which require the throttle foot to be raised up and back, before transitioning and only then to push forward on a brake control. This as noted, is the exact opposite of any driver's instinctual physiological and psychological response to an oncoming emergency which requires de-acceleration, especially under stressful, fast changing traffic and emergency conditions.

The present invention involves the recognition of a previously unknown and unestablished natural and instinctual physiological response to approaching emergency conditions, and a re-arrangement and reshaping of conventional motor vehicle foot controls to aid such instinctual response. Experimentation has discovered a very natural and instinctual human response student pilots undergo when approaching dangerous flying conditions. Further experimentation has observed the exact same response from the drivers of motor vehicles approaching similar conditions. If this natural and instinctual physiological response had been recognized decades ago, and appropriate corrections to how we control a car, many thousands of lives could have been saved in the United States alone, and thousands upon thousands more world wide.

This instinctual maneuver from herein is to be referred to as the “Brake and Brace Response” to approaching danger, and, we all do it. When drivers and passengers get into a car to start a trip, they generally buckle-up (not always) and assume a more or less attentive and forward position, drivers especially more than passengers. But once the shifting of gears (if necessary) and maneuvering around traffic to achieve a normal cruse condition is accomplished, everyone seems to assume a more or less relaxed position, even the driver.

Most passengers will tend to spread their arms and legs with their toes pointing outward about ten to twenty degrees to the left and right respectively, providing a relaxed and comfortable seating position. The driver will do pretty much the same thing to what ever degree possible in the driver's crowded foot well. The driver's left arm will be resting on either the driver's lap, the left arm rest, or the window sill. The driver's left foot will be resting on the floor. The right foot will be either on the throttle or on the level floor if in automatic cruise control.

It is from this generally relaxed position that passengers will execute a three step process to brace as the driver performs the same three step process to “brace and brake” when approaching a dangerous condition. Most three step recoveries are made from a relaxed position once cruise has been established.

The first step in the brake and brace maneuver is for the foot and toes to turn to a more forward position. The second step is for the legs and feet to close to a more central position. Both of these first two steps may be performed at practically the same time. The third step is the primary step as it is not only the forward movement to brace, but the driver's essential movement to apply brakes. As the legs and feet close to a more central position, so do the arms to apply both hands on the steering wheel and to brace for possible impact. The first two lateral movements are the very most natural physiological response to protect the most sensitive and important functions of the human body, the sexual organs and the head. It is essentially a “close and push” maneuver. As the turning of the feet forward is the first step and takes the least time and effort, in the present invention it is this movement of the throttle foot that will be designed to initiate an immediate disengagement of throttle control and engagement of brake control under stressful situations.

In all preferred modes of the present invention, the left and/or central brake pedal/panel will always cover the largest control area per design so as to be easily available to either sliding foot from any position. There are two possible throttle/brake designs, either or a combination of which may be used in any of the modes to be shown in this disclosure. The first throttle/brake mode design will be referred to as an “Angular and Laterally Oriented Transition From Throttle to Brake System” which will be referred to as Model-A. It must be noted that the names and terms associated with the preferred modes and design of the present invention are given merely to aid in describing the preferred modes and therefor should not be considered limiting to the scope and operation of the device.

In this system, the throttle is placed in an approximate twenty degree angle position relative the vertical as there is less natural tendency for a driver to race or floorboard the throttle in an angled position. Those skilled in the art will recognize that the preferred modes discussed in this disclosure may be subject to modification and alterations without departing from the overall scope and intent of the invention and are anticipated.

The second throttle to brake mode is referred to as a “Forwardly Oriented Transition of Throttle Control to Brake Control System” and will be referred to as Model B. Each system has one and the same objective; to reverse the negative results experienced from the very natural and instinctual physiological and psychological driver responses to stressful emergency driving conditions that results from present automotive designs, to a more positive life-saving response with the designs of the present invention. In each of the two throttle-to-brake designs, and with least effort and confusion, the throttle, in actuality, becomes a brake that is available, without confusion, for immediate use by the left or right foot or both.

It should be further noted at this point that timing is of greatest importance as the time necessary to apply brakes will determine which of the three steps the driver will naturally end up eliminating. The shorter the time necessary to respond, the more steps will be naturally eliminated to achieve the most important primary step, that of pushing forward to “Brace and Brake”. With Model A, the time to respond is shortened considerably by allowing the initial turning forward of the throttle foot to initiate the movement of the foot forward to brake without first requiring the leg and foot to move left to a more central position over brakes. As will be shown, the simple lateral turning of the throttle foot forward will disengage the throttle and engage the brake in one step. Such action will reduce response time to less than one second.

With Model B, response time will be reduced to less than ¼ second or to immediate response by either foot, even while the throttle foot is still on the throttle and the left foot active on the clutch in manual transmission cars. The same principle as applied to the left foot for immediate braking also allows for the possible application of brake or clutch independently or simultaneously resulting in no loss of control during certain shifting operations.

In all preferred modes of the present invention, the throttle, brake and clutch control pedals/panels may vary in forward and aft length from the conventional firewall baffle to the leading edge of the driver's level floor, depending on the particular mode. The trailing edge of those panels that are not long enough to reach a hinged connection to the leading edge of the level floor, will be held to the floor by a contracting biasing means such as a spring located at the connection of the panel to its control linkage or shaft (not shown).

Such arrangement prevents the possibility of a forward sliding foot under-cutting a control panel and striking the control linkage or haft instead. The throttle and clutch control panels will preferably be wide enough to accommodate the average foot. The brake control panels, however, will preferably cover the greatest area possible in any particular mode whether it is operating as a single independent left or right brake or as one single brake panel from left to right to assure the easiest access of either sliding foot from any position with least physical and mental effort to the brake.

There is a generous use of forward and side foot stops in all modes to aid a driver's correct identification of foot control placement by feel. As an additional aid to such identification, the surface of all control pedals/panels will be friction oriented to further aid the preferred forward/aft or lateral movement of a sliding foot.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

The objects and advantages of the present invention which will become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1a depicts an elevated view of a prior art driving console, pedals, foot well, and floor of passenger and utility motor vehicles noting that the throttle and brake pedals are only separated by one or two inches at the most.

FIG. 1b shows a side view of FIG. 1a.

FIG. 1c shows another side view of the FIG. 1a.

FIG. 2a shows the front view of a particularly preferred automatic transmission motor vehicle's foot well of the present invention.

FIG. 2b shows a top view of the device of FIG. 2a.

FIG. 2c shows a side view of the mode of the device of FIG. 2a.

FIG. 2d shows another side view of the mode of the device of FIG. 2a.

FIG. 3a shows a front view of another preferred mode of the device.

FIG. 3b shows a top view of the mode of the device of FIG. 3a.

FIG. 3c shows a side view of the device of FIG. 3a.

FIG. 3d shows another side view of the mode of the device of FIG. 3a.

FIG. 4a show the front view of an additionally preferred automatic transmission motor vehicles foot well that is shown in the pedal configuration prior to any rearward extension towards panel length.

FIG. 4b shows a top view of the mode of FIG. 4a.

FIG. 4c shows the side view FIG. 4a.

FIG. 5a shows a front view the first rearward extension of control panels for an automatic transmission vehicle.

FIG. 5b shows a top view of the device of FIG. 5a.

FIG. 5c shows a side view of the device of FIG. 5a.

FIG. 6a shows a view of the extension of a manual transmission vehicle's controls to the pedal/panel position.

FIG. 6b shows a top view of FIG. 6a.

FIG. 6c shows a side view of FIG. 6a.

FIG. 7a shows a front view of the conversion of control shafts and linkages from the forward position of control panels to the rearward position at the leading edge of the driver's level floor.

FIG. 7b shows a front view of the mode of the device of FIG. 7a except for a automatic transmission vehicle.

FIG. 7c shows a side view of the device of FIG. 7a.

FIG. 8a shows a front view of the preferred Model-B mode of the device with the same basic outline as in FIG. 3a of Model-A.

FIG. 8b depicts a side view of the device of FIG. 8a.

FIG. 9a shows both the throttle and clutch control panels in a braking position noting that the brake can be designed to operate as one single brake system, or as two separate independent throttle and clutch braking systems.

FIG. 9b depicts both throttle and clutch in their normal idle positions.

FIG. 10a shows the throttle control panel to brake engagement system wherein the TCP is held to the railings by four sliding railing clamps.

FIG. 10b shows the end view of the control panel and its clamps.

FIG. 11a shows the Model-A preferred mode of the device that has eliminated the time consuming necessity of moving the leg and foot inward to the brake to achieve braking and has already been accepted for patent.

FIG. 11b shows the Model-B preferred mode of the device that eliminates the time consuming, awkward and unnatural necessity of moving the leg and foot up and back before achieving a position to brake, further depicting the throttle in a brake captured position.

FIG. 11c shows again a Model B mode of the device with an angular throttle providing more relaxed position for the foot which is less inviting to drag racing, in the throttle position.

### DETAILED DESCRIPTION OF THE PREFERRED EMBODIMENTS OF THE INVENTION

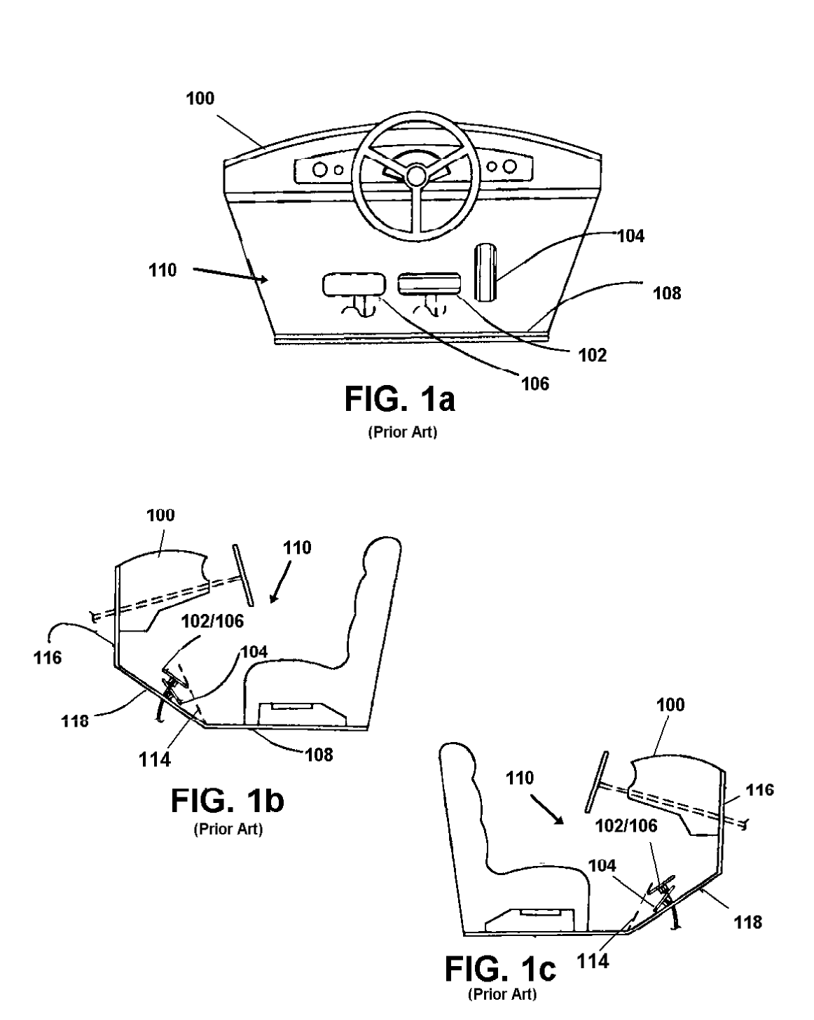

Now referring to drawings in FIGS. 1-11, wherein similar components are identified by like reference numerals, there is seen in FIG. 1a, 1b, and 1c, the conventional prior art driving console 100, foot well 110, brake pedal 102, throttle pedal 104, clutch pedal 106, and floor 108 of passenger and utility motor vehicles. Note that in FIG. 1a the conventional throttle 104 and brake 102 pedals of current vehicles are only separated by one or two inches at the most.

Also, note that in FIGS. 1b and 1c, on conventionally employed controls for vehicles, the throttle pedal 104 is always lower than both clutch 106 and brake 102 pedals, making it the easiest pedal to reach with the least effort. Take special note of the dotted line 114 representing a foot with its heel on the level floor, and the ball of the foot resting on a brake pedal at an approximate sixty degree angle. It is this angle that will be duplicated for all controls in the present invention. Also shown more clearly in side views, the foot well 110 generally includes a firewall 116 and foot control platform 118.

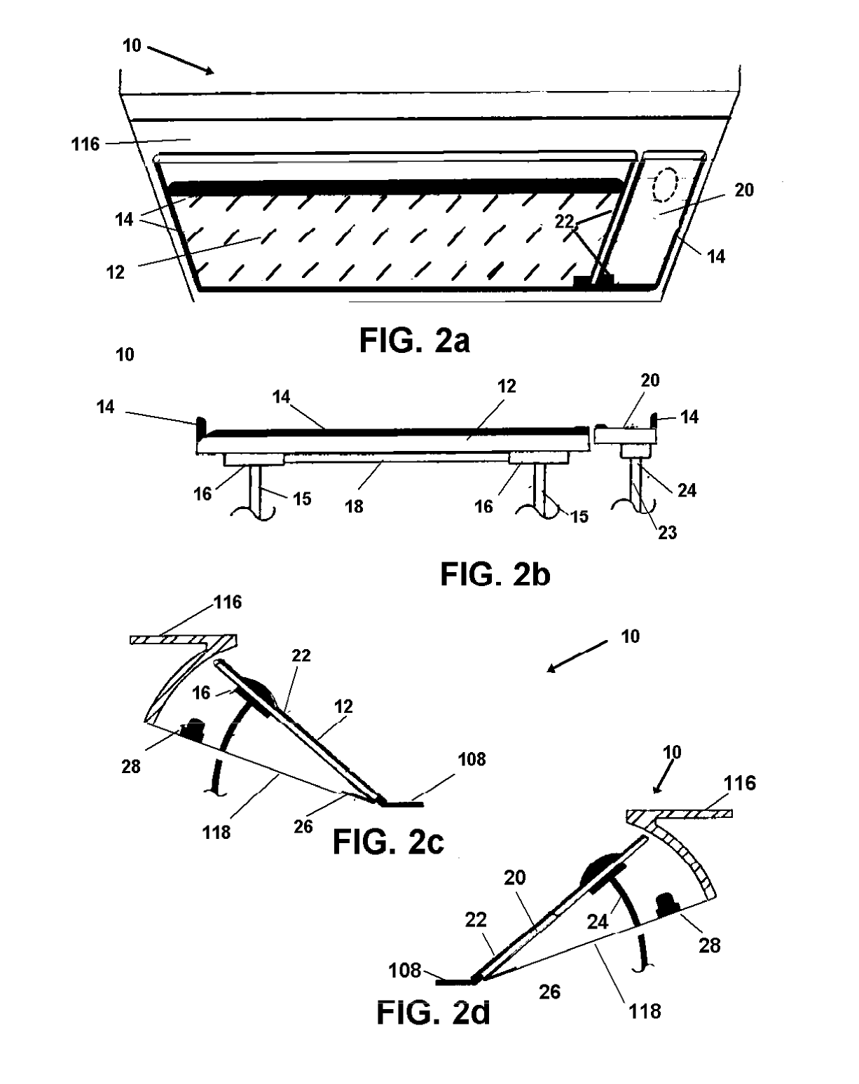

FIG. 2a shows the front view of an automatic transmission motor vehicle's foot well employing a particularly preferred mode of the disclosed device 10 of the present invention. A brake control panel 12, herein also referred to as the BCP, has replaced the prior art small brake pedal 102.

It is preferred that the panel 12 be a substantially large-area planar member providing for improved accessibility to either driver's foot from any position. As such those skilled in the art will appreciated that the modes of the device 10 depicted in the figures are capable of various modification and alterations to provide the improved foot accessability as described and are anticipated. It must be noted that the depictions set forth in the figures are merely to aid in providing a description for conveying the overall scope and intent of the device 10 and should not be considered limiting.

The BCP 12 includes foot stops 14, such as raised protrusions to maintain a user foot within the area of the BCP 12 when in use and prevent the foot from accidentally sliding off. In FIG. 2b, the BCP 12 is solidly attached to two hydraulic brake shafts 15 and attachment plates 16 which are firmly joined by a connector rib 18.

Further, the throttle control panel 20 or pedal, herein also referred to as the TCP, is preferably angled at approximately 20 degrees forming a rectangular parallelepiped. The right and left sides of the BCP 12 are also aligned at an approximate twenty degree angle. However, those skilled in the art will appreciate various other angles employable without departing from the scope and intent of the invention and are anticipated.

The right side of the BCP 12 and left side of the TCP 20 both communicate operatively with power cut-to-idle safety switches 22. The slightest touch of either of these switches 22 by either the right or left foot of a driver, will automatically and immediately cause throttle linkage 23 and attachment plate 24 to return to the idle position where it will remain unusable until the TCP 20 itself has returned to the idle position. The BCP 12 covers the entire foot well from the firewall baffle 116 to the leading edge of the driver's level floor 108 and from left to right, excluding the TCP 20.

It is particularly preferred that the BCP 12 is preferably ¼ inch lower (closer to the vehicle floor) than the TCP 20, however may be spaced more or less as needed. Such configuration allows the driver to easily identify the pedals by feel whether his or her laterally sliding foot is on the throttle or brake. FIG. 2c and FIG. 2d show side views of the current mode of the device 10 depicting the hinges 26 engage the BCP 12 and TCP 20 to the floor 108.

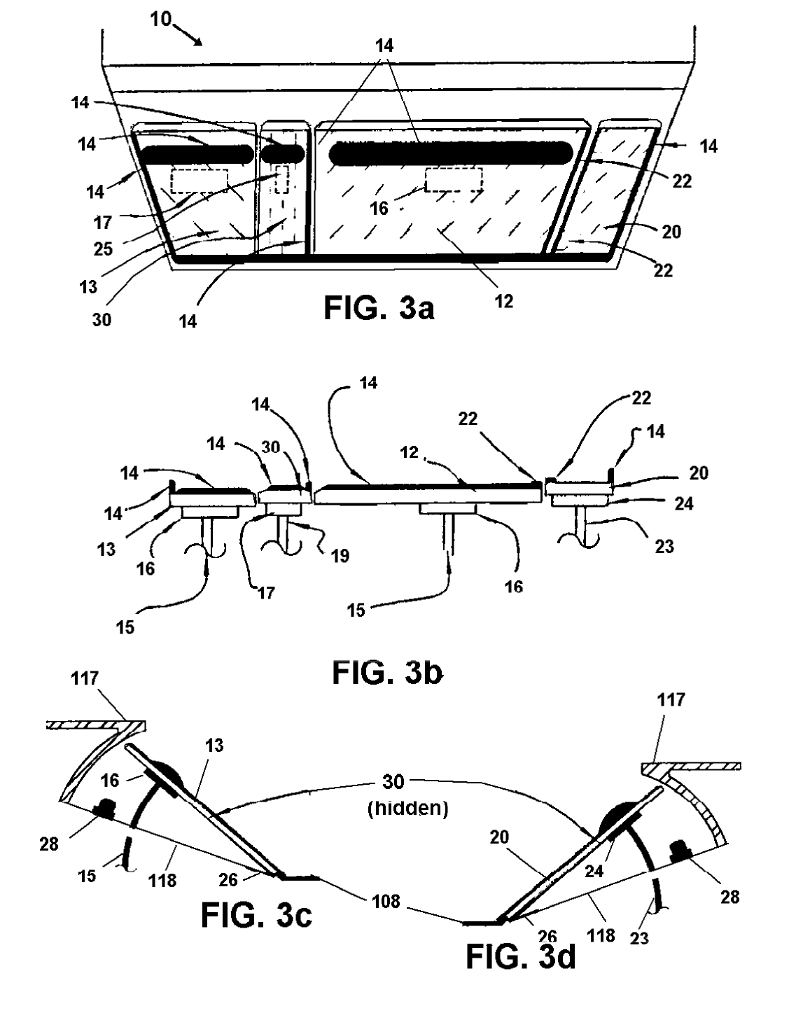

In FIG. 3a, FIG. 3b, FIG. 3c, and FIG. 3d there is shown a left BCP 13 and a clutch control panel 30, herein also referred to as the CCP, of a manual transmission vehicle, either of which may be operated separately by the left foot or together to avoid unwanted vehicle movement during certain gear shifting operations. The CCP 30 is engaged to the clutch control shaft 19 via the attachment plate 17.

The size of either left or right-positioned brake panels 12, 13 should be as large as possible for easier driver accessibility. Note the approximate two-inch space between the left BCP 13 and the CCP's forward foot stops 14. Note also the foot stops 14 on the left side of the throttle 20 and brake 12 and the left BCP 13. Again, this mode adds significantly to any driver's ability to accurately determine a foots correct placement by feel and without actually viewing them.

In the side views of FIGS. 3C and D, can be seen the presence of the CCP 30 that is hidden from view by the left BCP 13 in FIG. 3c and the TCP 20 in FIG. 3d, and the obstacle baffle 117 extending within substantially 3/16 inch of the control panels to prevent any possibility of obstacles falling between the BCP 12 and the foot control platform (FCP) 118 and interfering with its operation.

Also the addition of a floor safety button 28 below the TCP can be seen. As with the brake and throttle safety switches 22, the slightest communication of the floor safety button 28, by a descending TCP 20, will automatically and immediately cause the throttle linkage 23, to be reduced to the idle position where it will remain unusable until the TCP 20 has itself returned to the normal idle position. Any attempt by the driver to depress the throttle 20, either from panic or an attempt to drag race, will send a single computer impulse to deactivate the throttle.

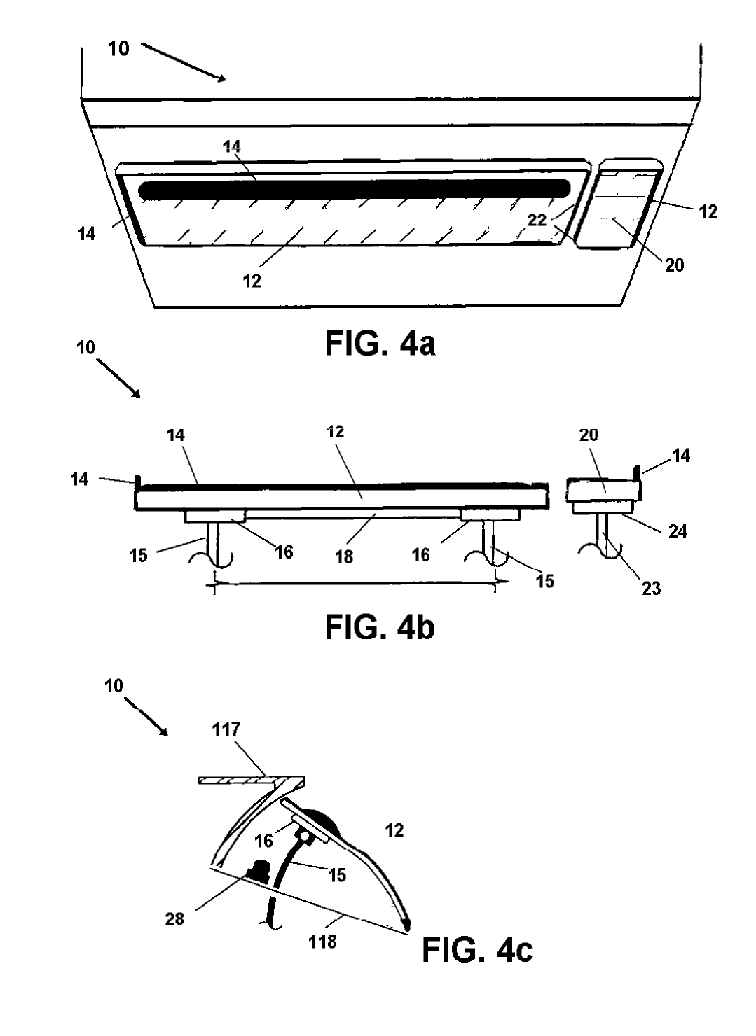

FIG. 4a and FIG. 4b show the top and front views of still another mode of the device 10 depicting an automatic transmission motor vehicles foot well that is still in the pedal configuration prior to any rearward extension towards panel length. FIG. 4c shows the end view of A and B. Note, as mentioned earlier, that the trailing edge of the pedals 12, 20 are held to the floor 108 by a spring loaded at the connection of the pedal to the brake shaft, (not shown). Such arrangement prevents any forwardly sliding foot from undercutting the pedal and hitting the shaft instead.

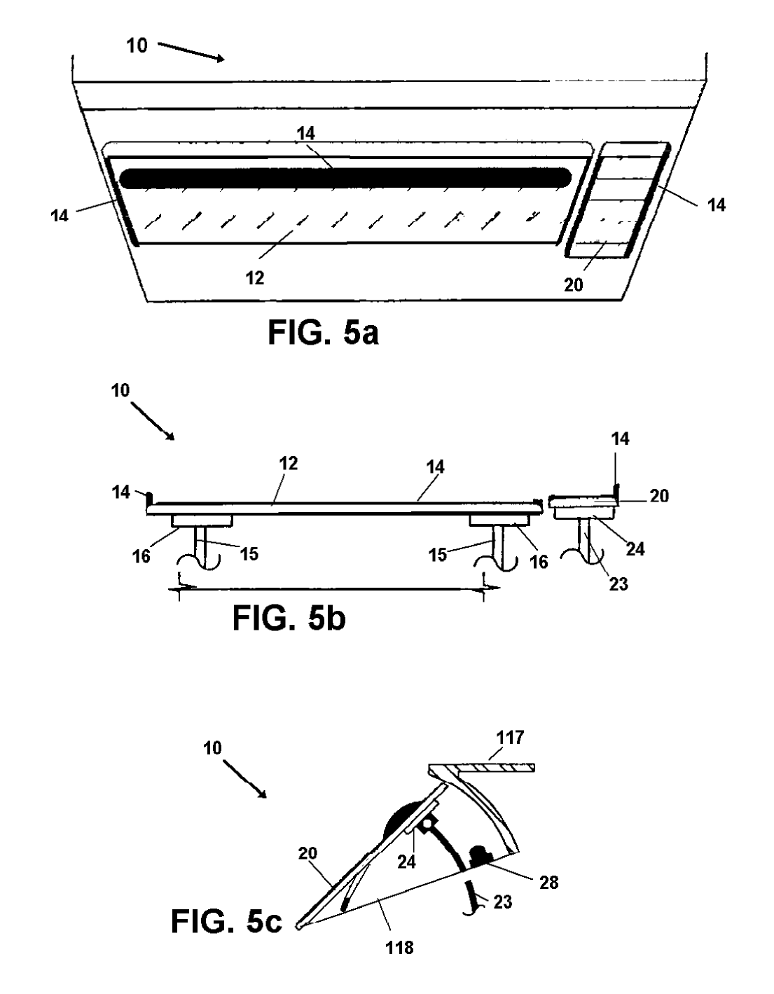

In FIG. 5a, FIG. 5b, FIG. 5c, there is shown the first rearward extension of control panels for an automatic transmission vehicle. This position may be referred to as the “pedal/panel” position. Any further rearward extension of controls would be referred to as a normal panel position hinged at the leading edge of the driver's level floor. All such extensions apply equally to automatic or manual vehicles.

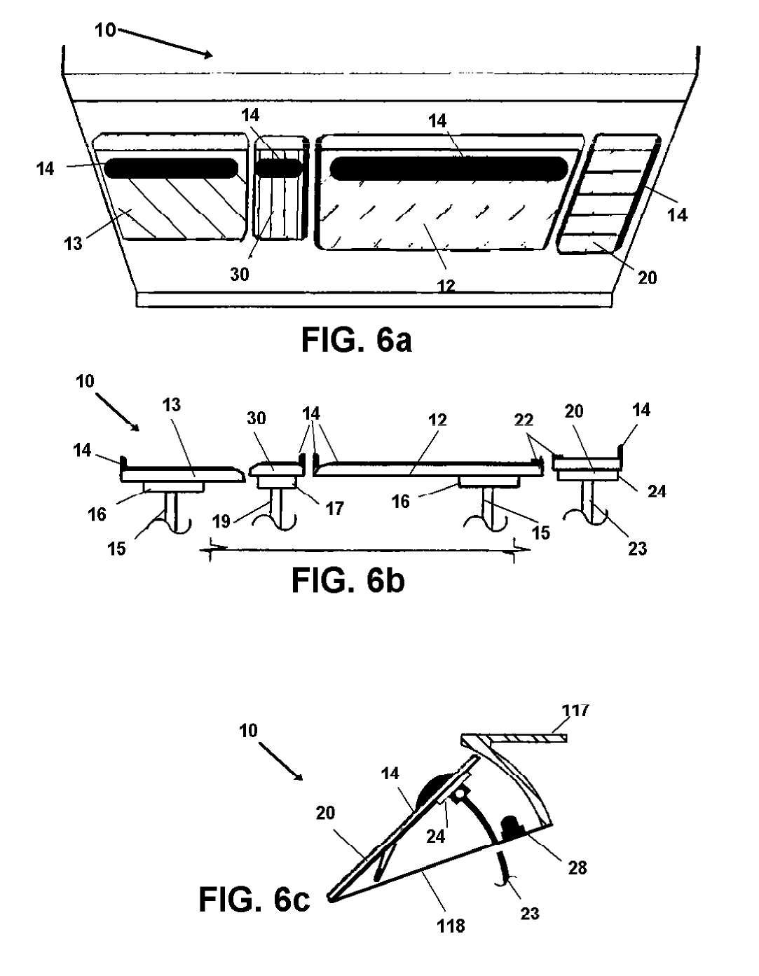

In FIG. 6a, FIG. 6b, FIG. 6c show the extension of a manual transmission vehicle's controls to the pedal/panel position. This model is basically the same as FIG. 5, except for the addition of the CCP 30 and left BCP 13. It should be noted at this point that the same configurations of pedal or panels as shown in FIGS. 4 and 5 will be basically the same for any manual transmission car.

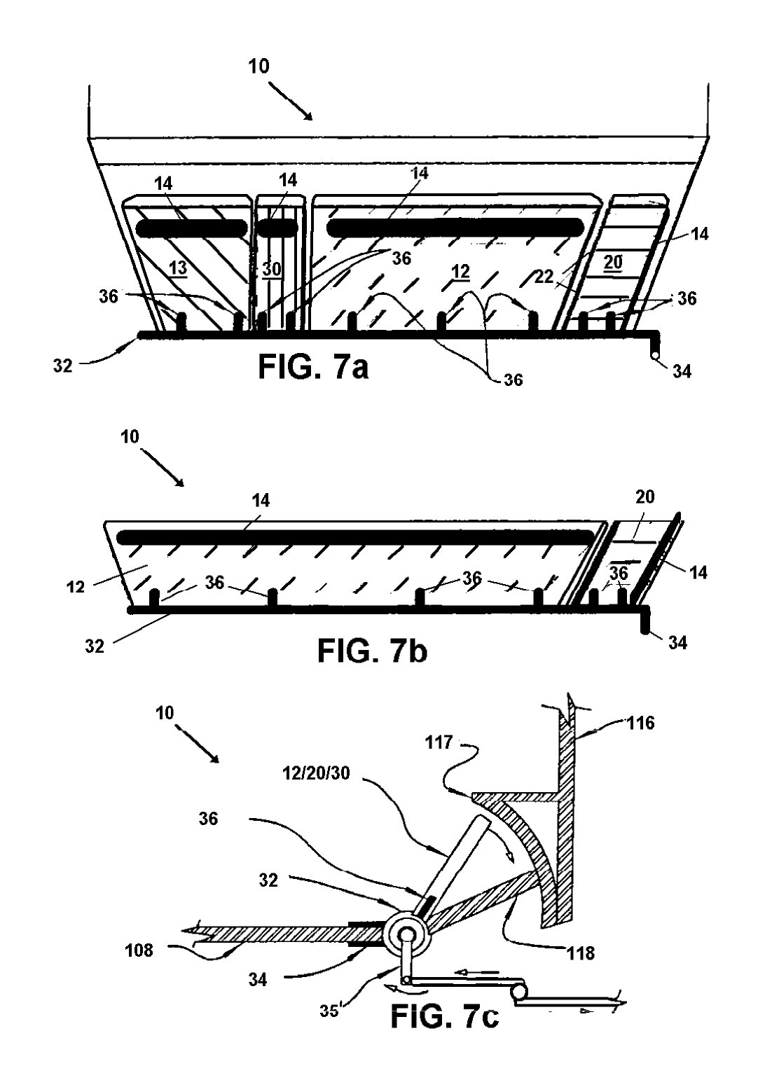

In FIG. 7a, FIG. 7b, FIG. 7c shows the conversion of control shafts and linkages from the forward position of control panels to the rearward position at the leading edge of the driver's level floor. FIG. 7c will apply equally to FIG. 7a, a manual transmission vehicle, as to 7b, an automatic transmission vehicle. Any and all brake control panels are fixedly attached to a brake control rod 32 running the full width of the foot well. Such brake control rod 32 is further fixedly secured to the leading edge of the driver's level floor by brake rod floor clamps 34 and rotates freely forward and aft in that position within certain design limits.

In FIG. 7A, both clutch 30 and throttle 20 control panels are attached to the brake control rod 32 by rod clamps 36 that rotate freely about the brake rod 32 within their individual design limits. A brake rod arm 35 extends from whatever position on the brake rod 32, left or right end or center, to connect to further brake linkage to effect braking. Similar extension arms will extend from both clutch 30 and throttle 20 control rod clamps 36 to connect with their respective functions (not shown).

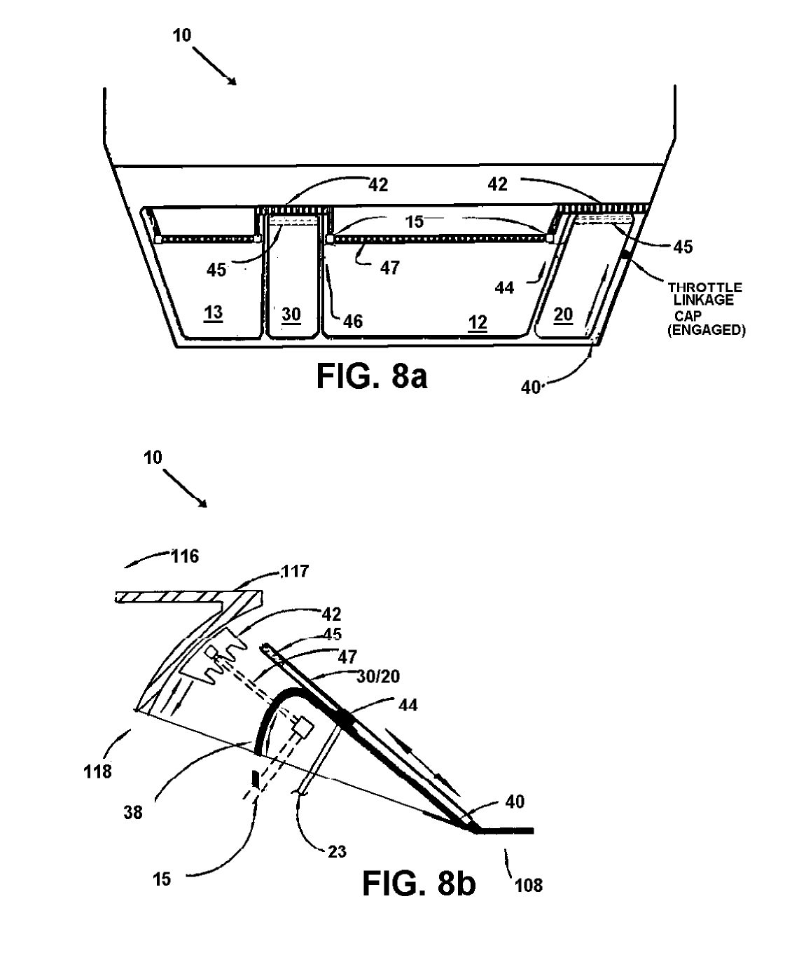

In FIG. 8a, FIG. 8b, showing a preferred Model B mode of the device 10 we see the same basic outline as in FIG. 3A of Model A. The only difference between Model A and B is that the throttle 20 can be disengaged and brake 12 engaged in the most natural, normal and instinctual forward motion of the throttle foot. When drivers instinctively move their throttle foot to brace for slowing down or stopping, they are automatically performing the exact same natural maneuver that is required to apply braking. Thus, a forward motion of the foot to brace is automatically converted to a downward motion to apply brakes.

The TCP 20 is freely allowed to slide forward on two railings 38, one on each side of the TCP 20 (only the left railing is shown in FIG. 8B), when forward pressure is applied by the throttle foot. Once the control panel 20 has moved forward more than ½ inch, the throttle disengagement switch 40 will automatically return throttle linkage 23 to the idle position where it will remain unusable until the control panel 20 itself has returned to its normal idle position. Once the control panel has proceeded forward more than substantially ½ inch, the leading edge of the control panel 20 will engage 45 the brake access cage 42, which is a lateral extension 47 of the vertical brake shaft 15.

At the same time, a throttle/brake cap 44 located on the left side of the control panel 12 ½ inch reward from the vertical brake shaft 15 will move forward over the brake shaft 15 to force the brake shaft 15 downward. The three step process to accomplish conventional braking as identified previously, clearly shows the time consuming process necessary to apply immediate braking. Model A of the device 10 herein, eliminates the time consuming, awkward and unnatural necessity of raising the foot up and back to above brake pedal height. Model B of the device 10 herein, further eliminates the time consuming necessity of moving the leg and foot in a direction toward left, to a braking position.

Such design of the device 10 herein, leaves only one of the three steps left to perform. That is, the instinctual pushing forward of the foot on the accelerator, to both brace and brake. The CCP 30 is under the same basic control design as the TCP 20 having a clutch/brake cap 46.

With forward foot pressure it will freely slid forward on two railings 38 until the leading edge 45 of the CCP 30 engages the brake cage 42. Further forward foot pressure will be converted downward to activate brakes while at the same time activating the clutch, the normal function desired during such braking functions.

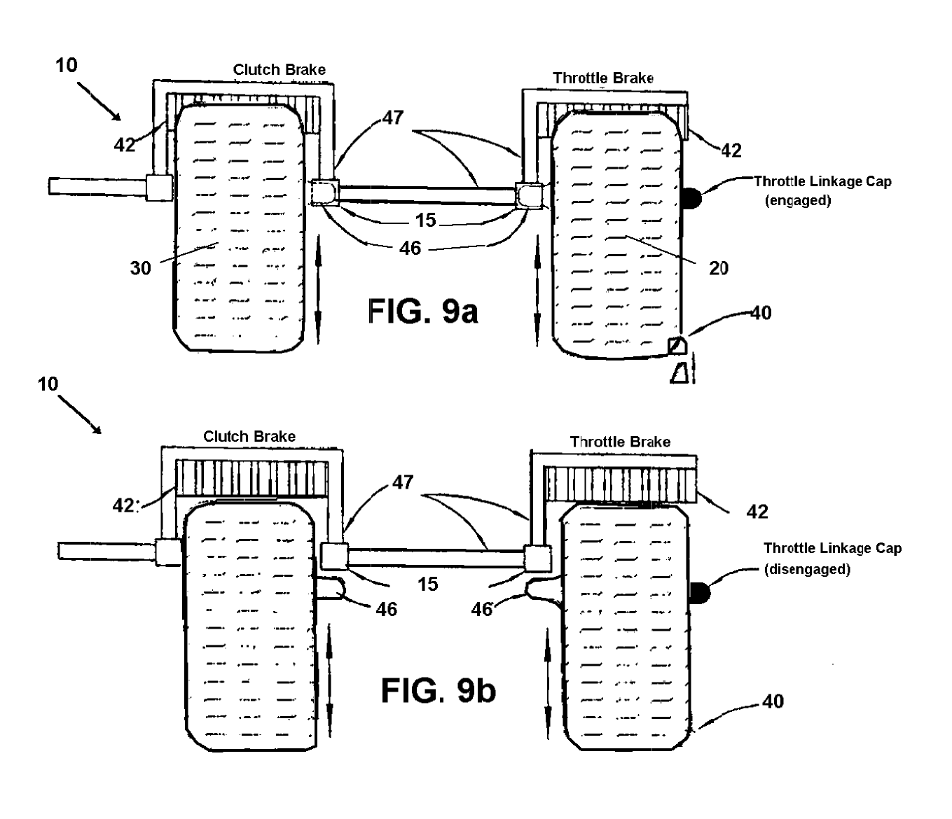

In FIG. 9a we see both the throttle 20 and clutch 30 control panels in a braking position. Take special note that the brake can be designed to operate as one single brake system, or as two separate independent throttle and clutch braking systems. FIG. 9b shows both throttle 20 and clutch 30 in their normal idle positions.

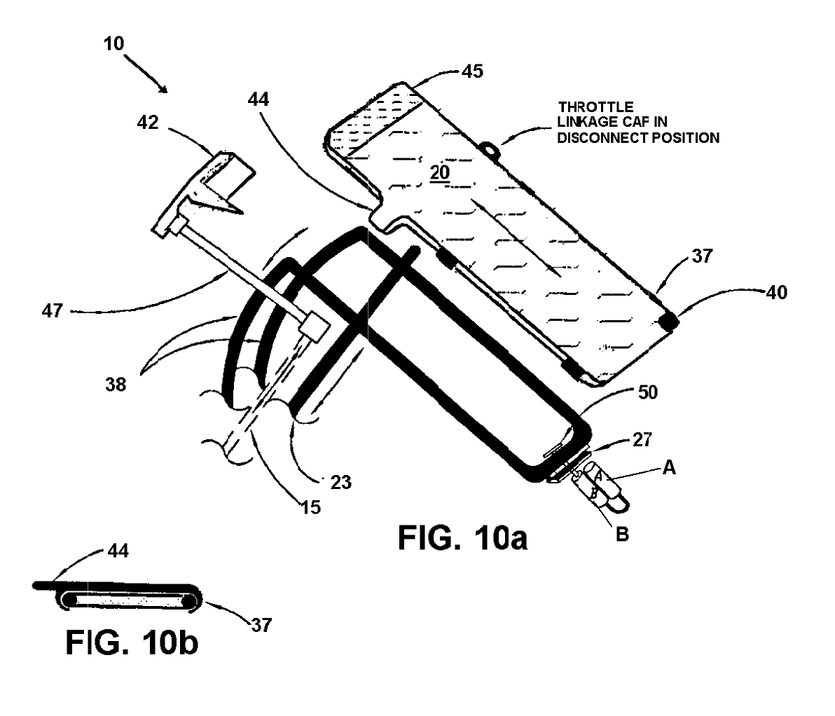

FIG. 10a is an oblique drawing of the throttle control panel 20 to brake 12 engagement system. The TCP 20 is held to the railings 38 by four sliding railing clamps 37. The aft end of the railing 38 is hinged 27 to the forward portion of the drivers level floor 108. FIG. 10B shows the end view of the control panel and 20 its clamps 37. The brake access cage 42 may have several steps available for the engagement of a TCP 20 which may already be in a position of throttle usage. When the foot goes forward to apply brakes, fluid from hydraulic cylinder A swiftly flows to cylinder B.

When downward brake pressure is released, the railing 38 is spring loaded to immediately return to the normal level position. However, it will not return immediately to its normal rearward position to re-engage throttle 20 as its rate of return is slowed considerably by a panel return stop 50 connected to cylinder B whose fluid is slowly returning to cylinder A. Though not shown, the control panel 20, however, will not return to its normal rearward position for throttle operation until it first returns to the level position.

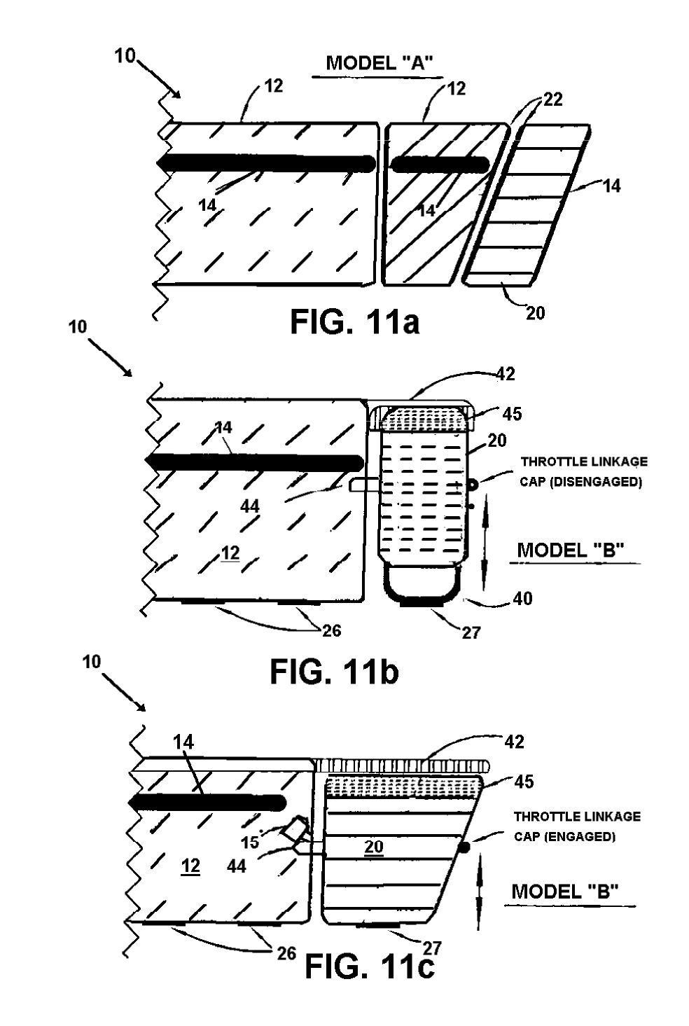

FIG. 11a, FIG. 11b, and FIG. 11c shows both Model-A and Model-B preferred modes of the device 10. FIG. 11A shows a Model A mode, that has eliminated the time consuming necessity of moving the leg and foot inward to the brake 12 to achieve braking.

FIGS. 11b and 11c show Model B of the same basic design that eliminates the time consuming, awkward and unnatural necessity of moving the leg and foot up and back before achieving a position to brake. FIG. 11B shows the throttle 20 in a brake captured position. FIG. 11c shows the angular throttle, a more relaxed position for the foot which is less inviting to drag racing, in the throttle position.

Although no schematic for the computer control function is shown, the function as its operation is simple and self evident and will accomplish the following by single computer impulses. An immediate reduction of throttle linkage 23 to idle where it will remain unusable until the TCP 20 itself has returned to its normal idle position anytime there is:

1) a drivers foot touches a BCP 12 or TCP 20 safety switch;
2) a TCP 20 make contact with the FCP 118 safety button;
3) an excessively rapid increase of acceleration beyond a limit set by the National Traffic Safety Administration (NHTSA).
4) an excessive and simultaneous use of power and brake beyond limits set be the NHTSA.

To avoid the possibility of a fire caused by an electrical spark igniting loose fuel caused by an impact, all fuel and electrical will be shut off at its source with anti-fire solution released in the fuel tank anytime pressure is experienced beyond a certain point set by the NHTSA or when an air bag is deployed.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An improved motor vehicle speed and braking control system comprising:
a throttle pedal moveable by a driver's throttle-foot, to control an engine of said vehicle to regulate provided engine power;
said throttle pedal operatively positioned above a support surface of a driver's foot well, and being moveable between an accelerated position and idle position;
a brake control in such position as most favorable for the immediate and natural application of brake by said throttle-foot;
a throttle safety switch in close proximity to the throttle pedal and the driver's throttle-foot;
said safety switch positioned to continuously occupy a position slightly higher above said support surface than that of said throttle pedal in both said accelerated and said idle positions;
said safety switch, when activated by the slightest communication with said throttle-foot, or any other object, causing an immediate reduction state of said power to that of said idle position;
said reduction state of said power continuing until said throttle control pedal has been returned to said idle position and said communication with said throttle-foot or object has ceased; and
whereby said driver's instinctual physiological and psychological response to a perceived need to de-accelerate said vehicle is encouraged and accommodated.

2. The improved motor vehicle speed and braking control system of claim 1, additionally comprising:
such throttle pedal having a shape which is substantially rectangular and to fit said driver's foot;
said throttle pedal angled to the right 10 to 20 degrees forming a parallelepiped; and
wherein such safety switch will attach along a left side of the parallelepiped throttle control pedal or panel.

3. A forwardly oriented motor vehicle speed and braking control system comprising:
a throttle pedal moveable by a driver's throttle-foot, to control an engine of said vehicle to regulate provided engine power;
said throttle pedal operatively slidingly engaged at a base, above a support surface of a driver's foot well, and being moveable between an accelerated position and idle position and to cause a corresponding output of said engine power;
said throttle control pedal in close proximity to a safety switch;
said safety switch is activated to cause said engine to change to that of said idle position, any time said throttle foot forces a first forward sliding of said throttle pedal toward a front end of said vehicle; and
said throttle pedal operatively communicating with brake linkage of said vehicle wherein any further said forward sliding pressure, forward of said first forward sliding, is communicated as to said brake linkage to cause a braking of said vehicle.

4. The forwardly oriented motor vehicle speed and braking control system of claim 3, additionally comprising:
said first sliding being at least one inch; and
a return of said throttle pedal in excess of one inch causing said braking to cease and to allow movement of said throttle pedal between said accelerated and idle position to cause a corresponding output of said engine power.

5. An angularly oriented motor vehicle speed and braking control system for right foot braking comprising:
a brake pedal engaged to a support surface of a driver's foot well, having an angular right side of which is of the same angular shape as an adjacent throttle pedal;
said right side being within 3/16 of an inch of a left side of said throttle pedal;
said brake pedal having a left side which is forwardly oriented forming a fan shape; and
a power reduction safety switch running the full length of the angular right side of the brake control and parallel to and within 3/16 inch from the throttle safety switch.

6. The system of claim 1, additionally comprising:
any space within said driver's foot well not covered by said throttle pedal, being covered by said brake pedal.

7. The system of claim 3, additionally comprising:
any space within said driver's foot well not covered by said throttle pedal, being covered by said brake pedal.

8. The system of claim 5, additionally comprising:
any space within said driver's foot well not covered by said throttle pedal, being covered by said brake pedal.
